(19) United States
(12) Patent Application Publication
(10) Pub. No.: US 2006/0129257 A1
(43) Pub. Date: Jun. 15, 2006

(54) Novel method and apparatus for integrating fault detection and real-time virtual metrology in an advanced process control framework

(75) Inventors: Ping-Hsu Chen, Hsinchu City (TW); Sunny Wu, Douliou City (TW); Bing-Hung Chen, Lioujia Township (TW); Francis Ko, Taichung City (TW); Chun-Hsien Lin, Hsin-Chu (TW)

Correspondence Address: TUNG & ASSOCIATES;Suite 120, 838 W. Long Lake Road, Bloomfield Hills, MI, 48302, US

(73) Assignee: Taiwan Semiconductor Manufacturing Co., Ltd.

(21) Appl. No.: 11/011,950

(22) Filed: Dec. 13, 2004

(51) Int. Cl. G06F 19/00

(52) U.S. Cl. 700/96; 700/121

(57) ABSTRACT

A semiconductor manufacturing information framework to operate a processing tool includes a data acquisition system (DAS), a virtual metrology (VM) system, a fault detection and classification (FDC) system and an advanced process control (APC) system. The DAS is operable to receive data related to the processing of a workpiece by the processing tool or sensors coupled on tool. The VM system is operable to receive the data from the DAS and predict results of the workpiece processed by the processing tool or sensors. The VM system generates at least one first output indicative of the results. The FDC system is operable to receive the data and generate at least one second output indicative of an operating status of the processing tool. The APC system is operable to receive the at least one first or second outputs, and, in response, generate at least one third output to control the processing tool.

### BACKGROUND

The present invention relates generally to semiconductor manufacturing, and, more particularly, to a method and apparatus for controlling the manufacturing process using information obtained from fault detection and classification (FDC) systems, metrology tools and advanced process control (APC) systems.

Since the introduction of integrated circuit (IC) devices, there has been a continuous drive to improve their quality, reliability and cost/unit. This drive has been fueled by consumer demands for improved computers and electronic devices, which operate more reliably, cost less, are more compact and use less power.

In a semiconductor fabrication process, IC's and semiconductor devices are formed by sequentially forming features in sequential layers of material in a bottom-up manufacturing method. The manufacturing process utilizes a wide variety of processing and measuring tools and techniques to form the various layered features including various deposition techniques and thermal growth techniques. The processing tool performs the various processing functions as defined by a recipe for the manufacture of the semiconductor device.

Measurements are often performed during the manufacturing process of an IC to determine whether a process (or process flow) will result in the intended end result. The term ‘metrology’ generally refers to the tools and techniques for measuring various parameters, such as thickness, dopant concentration and gate length, associated with semiconductor devices on test and/or production wafers. Metrology tools may typically be deployed in three different modes of operation: a) in-line operation (in which wafer measurements are performed between process steps), b) in-situ operation (in which the wafer is measured during processing), and c) off-line operation (in which the wafer is removed from the process line for measurement).

The following U.S. patents describe various aspects of improving operation of semiconductor manufacturing processes and are incorporated herein by reference: U.S. Pat. Nos.: 6,607,926; 6,597,447; 6,594,580; 6,563,300; 6,556,881; 6,556,884; 6,577,914; 6,594,589; 6,630,362; 6,630,360; 6,618,640; 6,563,300; 6,607,926; and 6,546,508.

FIG. 1 is an illustrative diagram of a manufacturing execution system (MES) based framework 100 for controlling and monitoring a semiconductor manufacturing process, according to prior art. A processing tool 110 is operable to process a workpiece such as a semiconductor wafer 120. Metrology tools such as pre-processing metrology tool 130 and post-processing metrology tool 140 measure pre and post processing values of wafer 120 attributes such as thickness, uniformity, hardness, stress, grain structure and the like. The post-processing metrology tool 140 generally measures wafer 120 results. Each tool generally interfaces to external devices by a corresponding tool interface.

Included in the MES based framework 100 are a FDC server 150, an APC server 160, and a statistical process control (SPC) server 170. The MES receives inputs from each of the tools 110, 130 and 140. The APC server 160 receives feedforward inputs 161 from the pre-processing metrology tool 130 and feedback inputs 162 from the post-processing metrology tool 140, and in response, adjusts one or more outputs 164 to control the processing tool 110 as defined by the recipe. Data describing the results of the wafer 120 processing by the processing tool 110 is typically measured by the post-processing metrology tool 140 and is stored in a database.

The FDC server 150 receives system variable identifier (SVID) information from the framework 100 as well as real-time data from various sensors (not shown) coupled to the tools 110, 130 and 140. The FDC server 150 analyses data received to detect, in real-time, tool and process deviations to identify a root cause. The SPC server 170 receives SVID information from the framework 100 to perform statistical process control.

Presently, there is no index or indicator to ensure that the tool status and/or process performance is within a desired operating range, especially after events causing the tool to go off-line such as preventative maintenance (PM) or equipment malfunction. Traditional techniques to re-establish normal status include processing one or more control or test wafers to collect data and monitor process performance. Another technique is to add metrology tools (including pre and/or post processing tool) to collect data. Adding metrology tools results in increased costs. Reducing monitor wafer costs has become an important consideration, especially for control wafers associated with 300 mm process.

In addition, many manufacturing frameworks deployed in modern semiconductor manufacturing facilities have no mechanism to integrate information obtained by the APC system 160, the FDC system 150 and various metrology tools 130 and 140 to improve the effectiveness of the processing tool 110 in the semiconductor manufacturing process. As a result, the FDC system 150 may provide tool health information but may be unaware of wafer 120 performance. Similarly, the APC system 160 may be used to control wafer 120 results but may not be aware of the real-time condition of the tools 110, 130 and 140.

Thus, a need exists to provide a reliable index or indicator to ensure tool status and process performance is within a desired operating range, especially after a PM or recovery event. In addition, a need exists to be able to provide the reliable index preferably without using a control wafer and/or by providing a virtual metrology tool operable to predict process tool performance.

In addition, a need exists to provide a total solution framework to integrate real-time information obtained by an APC system, a FDC system and various metrology tools to improve the semiconductor manufacturing process.

### SUMMARY OF THE INVENTION

The problems outlined above are addressed in a large part by an apparatus and method for improving the semiconductor manufacturing process, as described herein. According to one form of the invention, a semiconductor manufacturing information framework to operate a processing tool includes a data acquisition system (DAS), a virtual metrology (VM) system, a fault detection and classification (FDC) system and an advanced process control (APC) system. The DAS is operable to receive data related to the processing of a workpiece by the processing tool. The VM system is operable to receive the data from the DAS and predict results of the workpiece processed by the processing tool. The VM system generates at least one first output indicative of the results. The FDC system is operable to receive the data and generate at least one second output indicative of an operating status of the processing tool. The APC system is operable to receive at least one first or second outputs, and, in response, generate at least one third output to control the processing tool.

According to another aspect of the invention, the method for predicting at least one output of a virtual metrology (VM) tool includes receiving data related to processing of a workpiece by a processing tool. The data received includes measurement values for a plurality of variables indicative of the processing. A portion of the data in conformance with certain predefined selection criteria is selected. At least one key variable from the plurality of variables is selected such that the at least one key variable has a correlation index equal to or greater than a predefined value with the at least one output. The non-critical parameters for the at least one key variable are identified and filtered out to improve accuracy. A model for the VM tool is prepared by correlating the at least one output to selected variables from the plurality of variables. The selected variables include the at least one key variable and exclude the non-critical parameters.

Several advantages are achieved by the method and system according to the illustrative embodiments described herein. The embodiments advantageously provide for a system and method for an improved manufacturing process by providing a real-time diagnosis on wafer processing. The ability to predict results of wafer processing in real time is advantageously used to improve APC performance, optimize preventative maintenance schedule, reduce the amount of control wafers, and reduce the wafer cycle time. According to another aspect of the invention, the ability to integrate real-time information from APC/FDC and the VM tool is advantageously used to improve tool operation, increase manufacturing efficiency, reduce waste, increase control frequency and sampling rate, and reduce metrology tool loading and wafer cost. Additionally, the system and method described herein may be applied to all types of semiconductor manufacturing tools.

Other forms, as well as objects and advantages of the invention will become apparent upon reading the following detailed description and upon reference to the accompanying drawings.

### BRIEF DESCRIPTION OF THE DRAWINGS

Novel features believed characteristic of the invention are set forth in the appended claims. The invention itself, however, as well as a preferred mode of use, various objectives and advantages thereof, will best be understood by reference to the following detailed description of an illustrative embodiment when read in conjunction with the accompanying drawings. Elements, which appear in more than one figure herein, are numbered alike in the various figures.

FIG. 1 is an illustrative diagram of a manufacturing execution system (MES) based framework for controlling and monitoring a semiconductor manufacturing process, described herein above, according to prior art.

FIG. 2 is an illustrative schematic diagram of a VM tool for predicting wafer results, according to an embodiment.

FIG. 3 is an illustrative schematic diagram of a semiconductor manufacturing information framework to operate a processing tool, according to an embodiment.

FIG. 4A is a flow chart illustrating a method for predicting at least one output of the virtual metrology (VM) tool of FIG. 2, according to an embodiment.

FIGS. 4B, 4C, 4D, 4E and illustrate graphical representations of received data to generate at least one output of the VM tool of FIG. 2, according to one embodiment.

FIG. 5 is a flow chart illustrating a method for integrating information within the semiconductor manufacturing information framework of FIG. 3 to operate a processing tool, according to an embodiment.

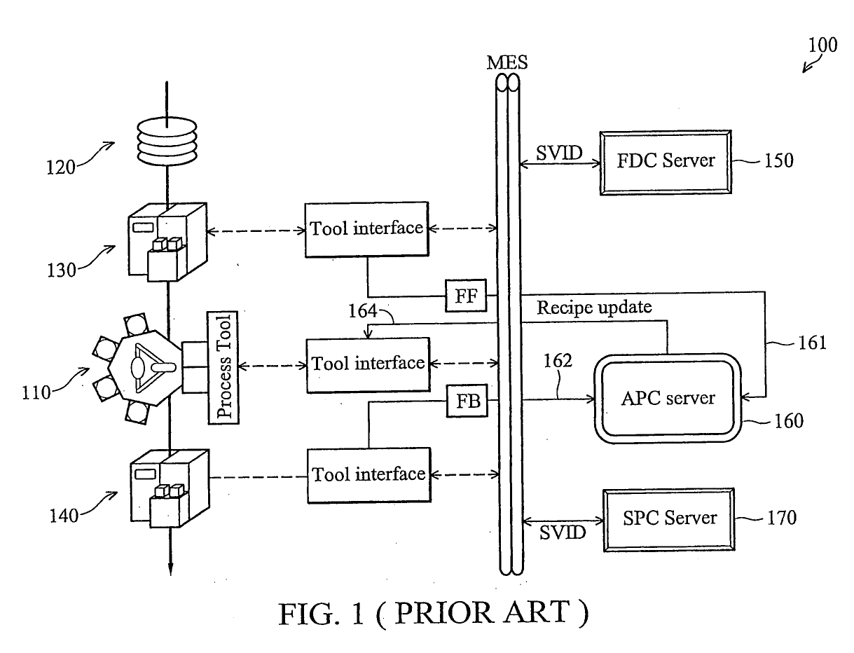

### DETAILED DESCRIPTION OF AN EMBODIMENT

While the invention is susceptible to various modifications and alternative forms, specific embodiments thereof are shown by way of example in the drawings and will be described herein in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Traditional semiconductor manufacturing processes have relied on use of measurement and control systems such as FDC systems, APC systems and various metrology tools. However, presently there is no mechanism to integrate information obtained by the APC system 160, the FDC system 150 and the various metrology tools 130 and 140 to improve the manufacturing process. The present invention describes an apparatus and method to improve the semiconductor manufacturing process. According to one form of the invention, a semiconductor manufacturing information framework to operate a processing tool includes a data acquisition system (DAS), a virtual metrology (VM) system, a fault detection and classification (FDC) system and an advanced process control (APC) system. The DAS is operable to receive data related to the processing of a workpiece by the processing tool. The VM system is operable to receive the data from the DAS and predict results of the workpiece processed by the processing tool. The VM system generates at least one first output indicative of the results. The FDC system is operable to receive the data and generate at least one second output indicative of an operating status of the processing tool. The APC system is operable to receive the at least one first or second outputs, and, in response, generate at least one third output to control the processing tool.

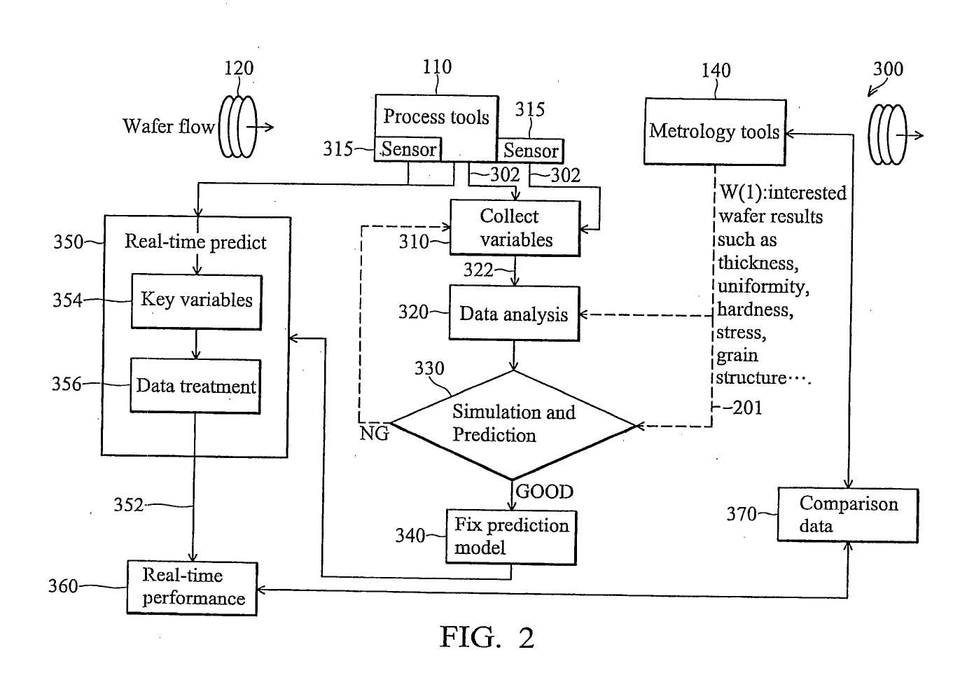

FIG. 2 is an illustrative schematic diagram of a VM tool 300 for predicting wafer results, according to an embodiment. A data collection module 310 collects data 302 related to a plurality of variables describing the wafer 120 processing by the processing tool 110. The data 302 may include real-time measured values of the plurality of variables, e.g., SVID's, which have been measured by one or more sensors 315 coupled to the processing tool 110. The data 302 may also include historical data and/or computed values.

A data analysis module 320 is operable to perform multi-variable analysis on data 302 received. The data analysis module 320 receives the collected data 302 as input 322, and the wafer data 201 as another input and in response generate at least one key variable having a correlation with the interested wafer results.

A simulation and prediction module 330 is operable to determine whether the at least one key variable identified by the data analysis module 320 has a correlation index which is greater than or equal to a predefined value. If the at least one key variable identified by the data analysis module 320 has a correlation index which is less than the predefined value output then a different set of data collected by the collection module 310 is selected.

If the at least one key variable has a correlation index which is greater than or equal to the predefined value, then a VM model 340 is defined to predict the results of the wafer 120 processing. The VM model 340 includes the at least one key variable. In one embodiment, the VM model 340 is substantially similar to the VM model 228.

A real-time prediction of the performance of the processing tool 110 is generated by a real-time prediction module 350. The real-time prediction module 350 receives real-time data 302 and applies it to the VM model 340 to predict at least one output 352 indicative of the results of the wafer 120 processing. In one embodiment, real-time prediction module 350 includes an identifier for the key variables 354 and data treatment 356 for the predicted data. The real-time performance module 360 stores data including various health indices to indicate the status of the processing tool 110.

A comparison module 370 compares results data stored in the real-time performance module 360, which has been generated by the real-time of the VM model 340, with corresponding real results data measured by post-processing metrology tool 140. The VM model 340 may be fine-tuned based on deviation error between the predicted versus actual results. In one embodiment, the VM tool 300 may replace a real metrology tool.

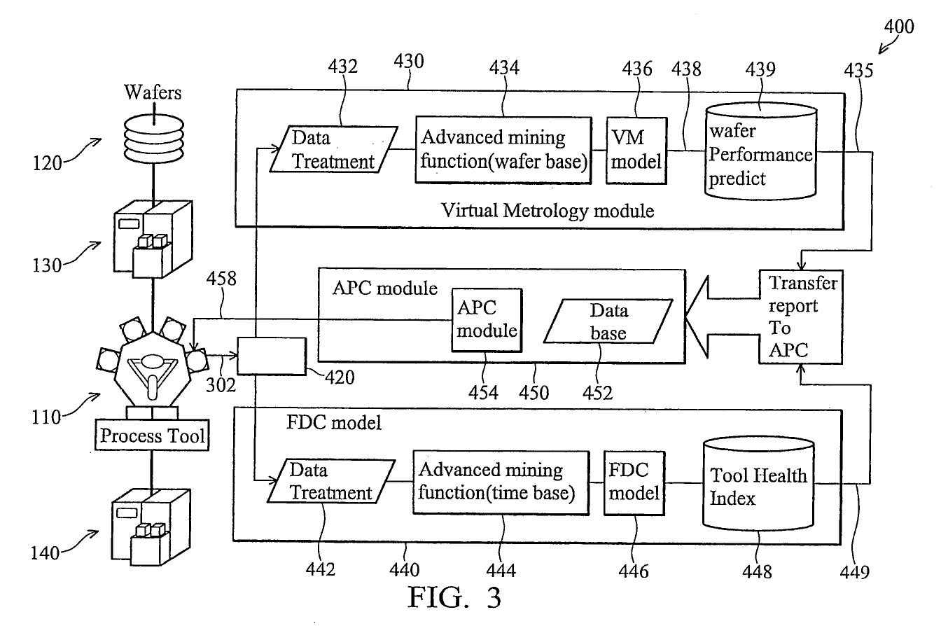

FIG. 3 is an illustrative schematic diagram of a semiconductor manufacturing information framework 400 to operate a processing tool, according to an embodiment. In the depicted embodiment, the semiconductor manufacturing information framework 400 is used to operate the processing tool 110. The framework 400 includes a data acquisition system (DAS) 420, a virtual metrology (VM) system 430, a fault detection and classification (FDC) system 440 and an advanced process control (APC) system 450. In one embodiment, the VM system 430 may be substantially similar to the VM tool 200. In one embodiment, the VM system 430 may be substantially similar to the VM tool 300.

The DAS 420 is operable to receive/acquire data 302 related to the processing of a workpiece, e.g., the wafer 120, by the processing tool 110. In one embodiment, the data 302 may be acquired by the various sensors 315 (not shown) and/or be computed values. In one embodiment, the data 302 includes SVID information.

The VM system 430 is operable to receive data from the DAS 420 and predict results of the workpiece processed by the processing tool 110 before measuring the results. In one embodiment, the VM system 430 includes a data treatment module 432, an advanced data mining/data analysis module 434, a VM model 436 and a wafer performance predict module 439. The data treatment module 432 is operable to receive the data 302 from the DAS and generate computed values such as averages, means, deviations and the like. The advanced data mining/data analysis module 434 is operable to perform PCA/PLS type multi-variable analysis to correlate one or more key variables with the data 302. In one embodiment, the VM model 436 is based on the data analysis performed by the advanced data mining/data analysis module 434. The VM model 436 generates at least one first output 438 indicative of the results of the wafer 120 processing before measuring the results. In one embodiment, the at least one first output 438 includes an overall index and/or indicator related to the wafer 120 processing result. The wafer performance predict module 439 stores the predicted results in a database. In one embodiment, one or more values of the at least one first output 438 are stored. In one embodiment, the at least one first output 438 is passed through as the output 435 to other modules. In another embodiment, it may be passed on an index of the results as the output 435 to other modules. In one embodiment, the output 435 is substantially the same as the at least one first output 438. In one embodiment, the VM model 436 may be substantially similar to the VM model 228, and/or the VM model 340.

The FDC system 440 is operable to receive the data 302 and generate at least one second output 449 indicative of an operating status of the processing tool 110. In one embodiment, the at least one second output 449 is a tool health index generated in real-time and indicative of the current tool stability. Similar to the VM system 430 described above, the FDC system 440 includes a data treatment module 442, an advanced data mining/data analysis module 444, a FDC model 446 and a tool health index module 448, according to one embodiment. The FDC system 440 may be customized for each processing tool included in the manufacturing process.

The APC system 450 is operable to receive the outputs of the VM system 430 and the FDC system 440. In one embodiment, outputs 435 and 449 are received as inputs. In one embodiment, the at least one first and second outputs 438 and 449 are received as inputs. In response to receiving the inputs, the APC system 450 generates at least one third output 458 to control the processing tool 110. The APC system 450 advantageously integrates real-time information from the VM system 430, which provides real-time information about wafer performance, and the FDC system 440, which provides real-time information about tool health, to improve the operation of the processing tool 110, and hence of the semiconductor manufacturing process. In one embodiment, the APC system 450 advantageously modifies the recipe for the processing of the wafer 120 in real-time, in response to inputs from the VM system 430 and the FDC system 440. In one embodiment, the APC system 450 may be turned off or disabled and the processing tool 110 placed in non-APC control if either one of the at least one first or second outputs 438 and 449 indicate a problem with the wafer results an/or the tool health. In one embodiment, the APC system 450 includes a database 452 to store information provided by the VM system 430 and the FDC system 440. Using similar modeling techniques described to prepare the VM model 436, an APC model 454 is developed to generate the at least one third output 458. The APC system 450 may be customized for each processing tool included in the manufacturing process.

At the end of the processing cycle, the FDC system 440 is updated to generate an updated version of the at least one second output 449 indicative of the current tool health. The APC system 450 is also updated at the end of each wafer 120 processing cycle, and the control algorithm may be adjusted to modify the recipe settings for the processing tool 110.

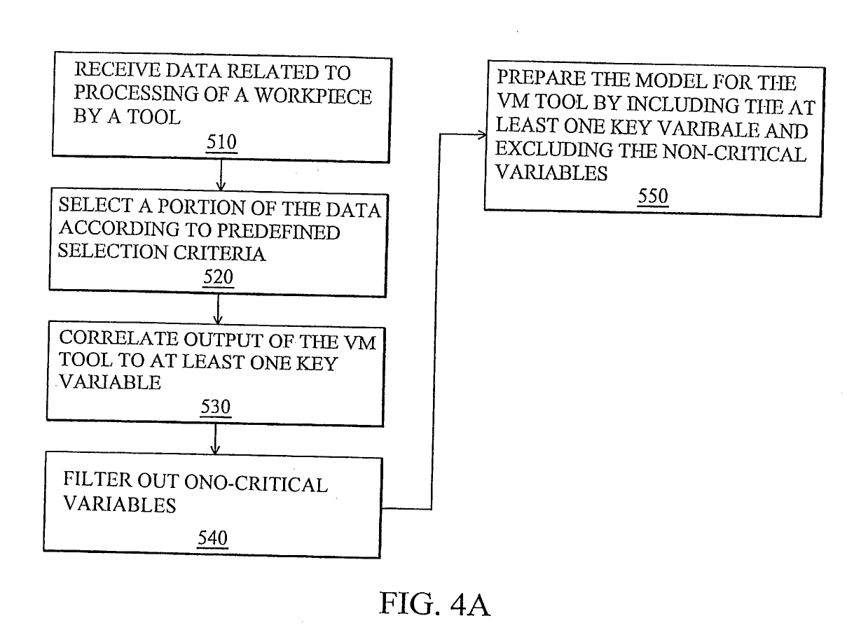

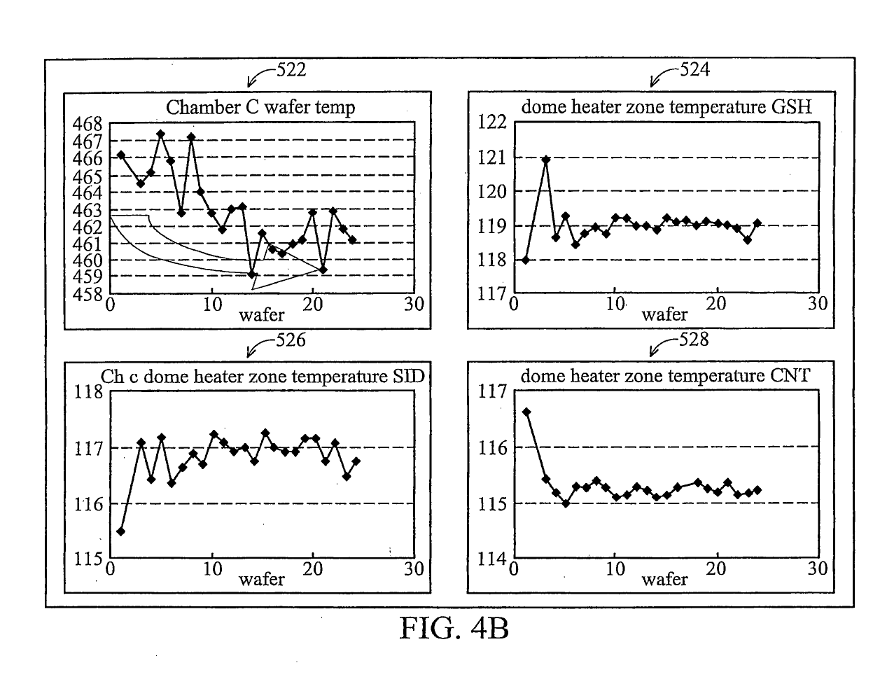

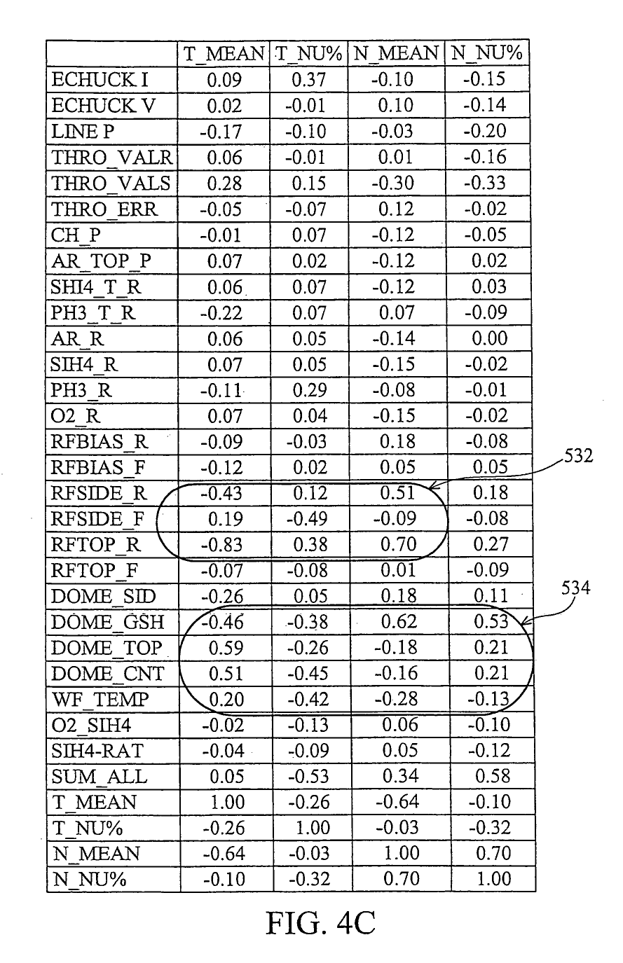

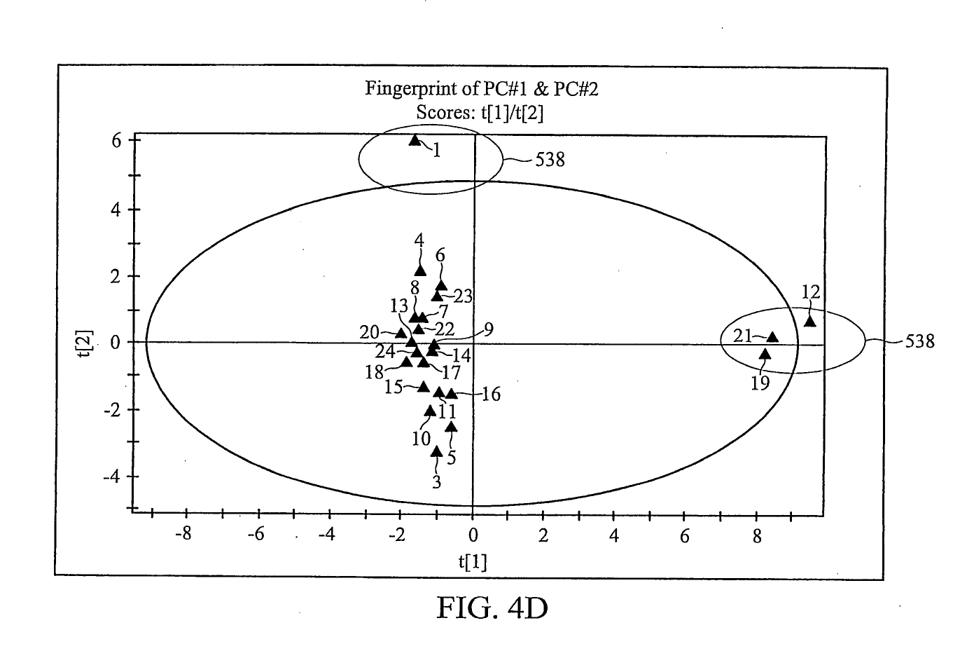

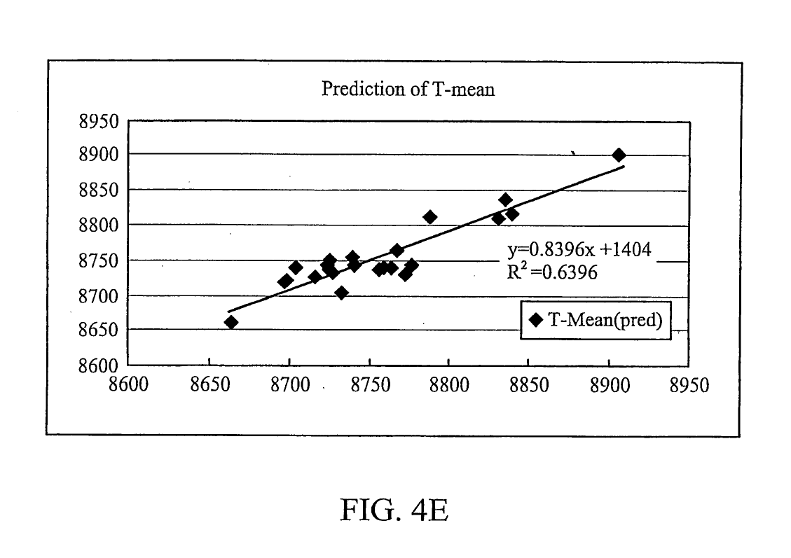

FIG. 4A is a flow chart illustrating a method for predicting at least one output of a virtual metrology (VM) tool, according to one embodiment. FIGS. 4B, 4C, 4D, and 4E illustrate graphical representations of received data to generate the at least one output of the VM tool developed for predicting thickness of a film layer deposited by high-density plasma (HDP) technique that is widely employed for inter-layer dielectric (ILD) applications, according to one embodiment. In one embodiment, the at least one output such as the at least one first output 438 is indicative of the results of the processing of the wafer 120 by the processing tool 110. In step 510, data related to processing of a workpiece by the processing tool 110 is received. In one embodiment, the data received includes measurement values for a plurality of variables such as SVID's indicative of the processing. Examples of the data received include data 302 and wafer data 201.

In step 520, a portion of the data is selected in conformance with certain predefined selection criteria. In one embodiment, the predefined selection criteria include selecting the data in conformance with time series data measurement values and/or data suitable for performing statistical process control on the processing tool as illustrated in FIG. 4B. Time series and SPC data is shown for SVID variables such as chamber wafer temperature 522, dome heater zone temperature 524, chamber dome heater zone temperature 526 and dome heater zone temperature 528.

In step 530, at least one key variable from the plurality of variables is selected such that the at least one key variable has a correlation index equal to or greater than a predefined value with the at least one output. Data correlation methods such as uni-variant analysis and multi-variant analysis are used to establish the correlation between the results, e.g., thickness, and one or more key variables received as inputs. FIGS. 4C and 4D illustrate graphical representation of performing uni-variant and multi-variant data analysis respectively of the received data, according to one embodiment. In FIG. 4C, RF 532 and dome temperatures 534 are shown to have a significant correlation index to thickness and coefficient of reflectance (T & N) value.

In step 540, non-critical parameters, e.g., outlier values, for the at least one key variable are filtered out to improve accuracy of prediction. In FIG. 4D, non-critical parameters 538 are filtered out to reduce error. In step 550, a model for the VM tool is prepared. As described earlier, examples of the model for the VM tool include VM models 228, 340 and 436. The model for the VM tool advantageously correlates the at least one output to selected variables from the plurality of variables. The selected variables, which are defined by steps 530 and 540, include the at least one key variable and exclude the non-critical parameters for the at least one key variable. For example, a model for a VM tool includes 5 key variables selected a total of 28 variables measured during the processing of the wafer 120. By receiving data on these 5 selected variables, the model is operable to predict results such as thickness without measured by a real metrology tool such as tool 140. FIG. 4E illustrates graphical representations of accuracy and the predicted results by the VM tool, according to one embodiment. The predicted result 556 of the VM model, e.g., the thickness, and its accuracy is shown in FIG. 4E. In one embodiment, the VM tool may replace a real metrology tool. Various steps of FIG. 4A may be added, omitted, combined, altered, or performed in different orders.

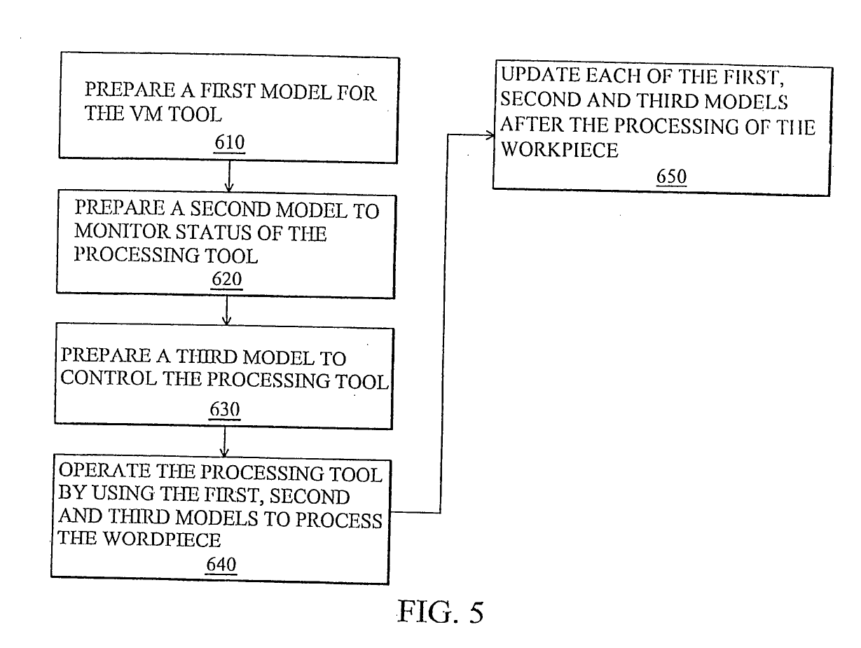

FIG. 5 is a flow chart illustrating a method for integrating information within the semiconductor manufacturing information framework 400 to operate the processing tool 110, according to an embodiment. In this embodiment, the framework 400 includes the DAS 420, the fault detection and classification (FDC) system 440, the virtual metrology (VM) system 430 and the advanced process control (APC) system 450.

In step 610, a first model, e.g., the VM model 436, included in the VM system 430 is prepared. The VM system 430 is operable to predict results of a workpiece processed by the processing tool 110. The first model generates at least one first output, e.g., the at least one first output 438, which indicative of the results without measuring.

In step 620, a second model, e.g., the FDC model 446, included in the FDC system 440 is prepared to monitor status of the processing tool 110. The second model generates at least one second output, e.g., the at least one second output 449, which indicative of the tool health status.

In step 630, a third model, e.g., the APC model 454, included in the APC system 450 is prepared to control the processing tool 110. The third model generates at least one third output, e.g., the at least one third output 458, for the control in response to receiving the at least one first and second outputs 438 and 449. In step 640, the first, second and third models are operable to control the results of the processing by the processing tool 110. In step 650, the first, second and third models are updated after the processing. Various steps of FIG. 5 may be added, omitted, combined, altered, or performed in different orders.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for predicting at least one output of a virtual metrology (VM) tool, the method comprising:
receiving data related to processing of a workpiece by a processing tool, wherein the data includes measurement values for a plurality of variables indicative of the processing;
selecting a portion of the data in conformance with predefined selection criteria;
selecting at least one key variable from the plurality of variables, wherein the at least one key variable has a correlation index equal to or greater than a predefined value with the at least one output;
filtering out non-critical parameters for the at least one key variable, wherein the filtering causes a reduction in an error in the prediction; and
preparing a model for the processing tool, wherein the model correlates the at least one output to selected variables from the plurality of variables, wherein the selected variables include the at least one key variable and exclude the non-critical parameters.

2. The method of claim 1, wherein the model is operable to predict the at least one output in response to the data received.

3. The method of claim 1, wherein the at least one output includes an index, the index being indicative of a result of the processing of the workpiece by the processing tool.

4. The method of claim 1, wherein the at least one output substantially correlates with a corresponding at least one output generated by a real metrology tool.

5. The method of claim 1, wherein the at least one output predicts results of the processing of the workpiece.

6. The method of claim 1, wherein the at least one output is predicted in real-time responsive to the data received in real-time.

7. The method of claim 1, wherein the predefined selection criteria includes selecting the data in conformance with time series data measurement values.

8. The method of claim 1, wherein the predefined selection criteria includes selecting the data suitable for performing statistical process control on the processing tool.

9. The method of claim 1, wherein the correlation index is determined by performing statistical, single-variable, multi-variable or neural network analysis on the portion of the data.

10. The method of claim 1, wherein the data is acquired by a sensor device coupled to the processing tool, the sensor device being operable to generate the measurement values for the plurality of variables.

11. A method for integrating information within a semiconductor manufacturing information framework to operate a processing tool, the framework including a fault detection and classification (FDC) system, a virtual metrology (VM) system and an advanced process control (APC) system, the method comprising:
preparing a first model included in the VM system, the VM system being operable to predict results of a workpiece processed by the processing tool, wherein the first model generates at least one first output indicative of the results;
preparing a second model included in the FDC system, the FDC system being operable to monitor status of the processing tool, wherein the second model generates at least one second output indicative of the status; and
preparing a third model included in the APC system, the APC system being operable to control the processing tool, wherein the third model generates at least one third output for the control in response to receiving the at least one first output or the at least one second output.

12. The method of claim 11, wherein the first, second and third models are operable to control the results.

13. The method of claim 11, wherein the second model is updated in response to the workpiece processed.

14. The method of claim 13, wherein the updated second model includes information indicative of the results.

15. The method of claim 11, wherein the first model is prepared by:
receiving data related to processing of the workpiece by the processing tool, wherein the data includes measurement values for a plurality of variables indicative of the processing;
selecting a portion of the data in conformance with predefined selection criteria;
selecting at least one key variable from the plurality of variables, wherein the at least one key variable has a correlation index equal to or greater than a predefined value with the at least one output;
filtering out non-critical parameters for the at least one key variable, wherein the filtering causes a reduction in an error in predicting the results; and
selecting variables from the plurality of variables to define the first model, wherein the selected variables include the at least one key variable and exclude the non-critical parameters variables.

16. A semiconductor manufacturing information framework to operate a processing tool, the framework comprising:
a data acquisition system operable to receive data related to processing of a workpiece by the processing tool or sensors coupled on tool, wherein the data received includes measurement values for a plurality of variables indicative of the processing;
a virtual metrology (VM) system operable to receive the data and predict results of the workpiece processed by the processing tool or sensors coupled on tool, the VM system generating at least one first output indicative of the results;
a fault detection and classification (FDC) system operable to receive the data and generate at least one second output indicative of an operating status of the processing tool; and
an advanced process control (APC) system operable to receive the at least one first or second outputs, and, in response, generate at least one third output to control the processing tool.

17. The framework of claim 16, wherein the FDC system is modified in response to the workpiece processed.

18. The framework of claim 17, wherein the modified FDC system includes information indicative of the results.

19. The framework of claim 16, wherein the VM system includes:
means for performing data analysis on the data received, wherein the data analysis includes correlating the at least one first output to selected ones of the plurality of variables;
means for defining a first model including the selected ones for predicting the results.

20. The framework of claim 19, wherein the selected ones includes at least one key variable from the plurality of variables, wherein the at least one key variable has a correlation index equal to or greater than a predefined value with the at least one output.
